(19) United States
(12) Patent Application Publication
(10) Pub. No.: US 2010/0190902 A1
(43) Pub. Date: Jul. 29, 2010

(54) ALKYLTIN SULFANYL ESTER THIOLS

(75) Inventor: Edward Krainer, New Fairfield, CT (US)

Correspondence Address: Patent Administrator;Chemtura Corporation, 199 Benson Road, Middlebury, CT, 06749, US

(73) Assignee: Chemtura Corporation, Middlebury, CT (US)

(21) Appl. No.: 12/360,712

(22) Filed: Jan. 27, 2009

(51) Int. Cl. C08K 5/58; C07F 7/22

(52) U.S. Cl. 524/179; 556/87

(57) ABSTRACT

Disclosed herein are compounds of the formula:

(R)ₓ—Sn—(R′)₄₋ₓ

wherein x is 1 or 2; R is alkyl of from 1 to 12 carbon atoms; and R′ is a moiety selected from the group consisting of:

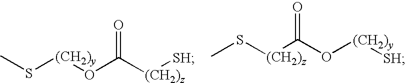

and mixtures thereof, wherein y is 1, 2, 3, or 4; and z is 1, 2, 3, or 4, and processes for forming such compounds. The compounds are excellent stabilizers for halogen-containing resins, such as PVC.

### FIELD OF THE INVENTION

The present invention relates to alkyltin thermal stabilizers for halogen-containing resin compositions. More particularly, the present invention relates to alkyltin sulfanyl ester thiols that have from one to three terminal thiol groups and are suitable for thermal stabilization of halogen-containing resin, e.g., PVC, compositions.

### BACKGROUND OF THE INVENTION

Conventional commercially available organotin stabilizers, such as alkyltin bis- and/or tris-(mercaptopropionates) and/or (thioglycolates) are prepared using mercaptoacids (such as mercaptoacetic and mercaptopropionic acids), an aliphatic alcohol and mono- or di-alkyltin chloride, where all SH-group are reacted with the alkyltin chloride (alkyl groups are methyl, n-butyl or octyl). Alkyltin oxides (especially butyltin oxide) are also known to be used as a source of tin.

U.S. Published Patent Application US20060252859, filed May 5, 2005, discloses an alkyltin compound of a specified formula that is said to have utility as a stabilizer for a halogen-containing resin. The alkyltin compound has from one to three terminal thiol groups. The heat stabilizing performances of dimethyltin bis(1,2-ethane dithioglycolate), monomethyltin tris(1,2-ethanedithioglycolate), dimethyltin bis(1,2-ethane dimercaptopropionate), monomethyltin tris(1,2-ethanedimercaptopropionate) and mixtures thereof are specifically disclosed.

U.S. Published Patent Application US20080132621, filed Dec. 5, 2006, discloses compounds of the formula:

(R)ₓ—Sn—(R′)₄₋ₓ

wherein R is alkyl; R′ is a moiety selected from the group consisting of:

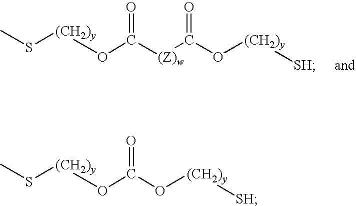

wherein w is 0 or 1; x is 1 or 2; y is 1, 2, 3, or 4; and Z is a linear, branched, cyclic, or aromatic hydrocarbon. These compounds are excellent stabilizers for halogen-containing resins, such as PVC.

U.S. Pat. No. 3,115,509 (see also GB 866,484) generically discloses condensation products of organotin compounds with dimercaptoacid esters of organic diols. These condensation products have the general formula:

RₓSn(—S-A-COO—B—OOC-A-SH)₄₋ₓ

wherein x is 1, 2, or 3, R is a univalent organic radical, A is a hydrocarbon group, B is a hydrocarbon radical, and the sum of the carbon atoms of A and B is preferably no more than 25, and are said to stabilize vinyl resins against the degradative effects of both heat and light.

U.S. Pat. Nos. 3,539,529 and 3,682,992 disclose compositions and a stabilized polyvinyl chloride resin composition comprising essentially, in a predominant amount, a polyvinyl chloride resin and, in a small amount, at least one boron-containing organotin compound having the formula:

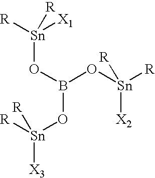

wherein R is a member selected from the group consisting of alkyl, alkenyl, aralkyl, alkylaryl and aryl; X₁ is a member selected from the group consisting of the residues of monomercapto compounds, dimercapto compounds and polymercapto compounds, said residues containing at least one free sulfhydryl radical; and X₂ and X₃ are members selected from the group consisting of hydroxyl, the same residues as X₁, the residues of carboxylic acids and maleic acid monoesters, and the residues of mercapto compounds containing no free sulfhydryl radical.

Non-thiol terminated alkyltin stabilizers are also known. For example, dimethyltin bis S,S(2-ethylhexanol thioglycolate) and di-n-butyl bis S,S(2-ethylhexanol thiolglycolate) are both commercially available. One of the most effective thermal stabilizers is a blend of dimethyltin bis S,S(2-ethylhexanol thioglycolate) and methyltin tris S,S,S(2-ethylhexanol thioglycolate), which is also commercially available.

The disclosures of the foregoing are incorporated herein by reference in their entireties.

The need remains for additional compositions that are suitable for stabilizing halogen-containing resin compositions.

### SUMMARY OF THE INVENTION

As noted above, the present invention relates to alkyltin thermal stabilizers that are particularly suited for stabilizing halogen-containing resin compositions. More particularly, the present invention relates to alkyltin sulfanyl ester thiols that have from one to three terminal thiol groups and are suitable for thermal stabilization of halogen-containing resin, e.g., PVC, compositions.

More particularly, the present invention is directed to a compound of the formula:

(R)ₓ—Sn—(R′)₄₋ₓ

wherein x is 1-3, preferably 1 or 2; R is alkyl; and R′ is a moiety selected from the group consisting of:

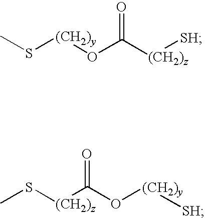

and mixtures thereof, wherein y is 1, 2, 3, or 4; and z is 1, 2, 3, or 4. R preferably is an alkyl of from one to eight carbon atoms, and more preferably is selected from the group consisting of methyl, butyl, t-butyl, ethylhexyl, and octyl.

In some exemplary embodiments, the compound is selected from the group consisting of dimethyltin bis(2-mercaptoethyl thioglycolate), monomethyltin tris(2-mercaptoethyl thioglycolate), dimethyltin bis(2-mercaptoethyl 3-mercaptopropionate), monomethyltin tris(2-mercaptoethyl 3-mercaptopropionate), dibutyltin bis(2-mercaptoethyl thioglycolate), monobutyltin tris(2-mercaptoethyl thioglycolate), dibutyltin bis(2-mercaptoethyl 3-mercaptopropionate), monobutyltin tris(2-mercaptoethyl 3-mercaptopropionate), dioctyltin bis(2-mercaptoethyl thioglycolate), monooctyltin tris(2-mercaptoethyl thioglycolate), dioctyltin bis(2-mercaptoethyl 3-mercaptopropionate), monooctyltin tris(2-mercaptoethyl 3-mercaptopropionate), didodecyltin bis(2-mercaptoethyl thioglycolate), monododecyltin tris(2-mercaptoethyl thioglycolate), didodecyltin bis(2-mercaptoethyl 3-mercaptopropionate), monododecyltin tris(2-mercaptoethyl 3-mercaptopropionate), and mixtures thereof.

These organotin compounds may be generally described as condensation products of organotin derivatives (such as oxides and chlorides) and mercaptoacid esters of mercaptoalcohols.

In another embodiment, the invention is directed to a composition comprising: (A) a halogen-containing resin; and (B) an effective amount of any of the above-described alkyltin sulfanyl ester thiols to stabilize the halogen-containing resin against elevated temperatures, UV light, oxidation, and high shear forces. For example, the halogen-containing resin may be selected from the group consisting of PVC and polyvinyl bromide. The effective amount may optionally is within a range of from about 0.5 to about 1.50 parts of the compound per hundred parts the resin.

In another embodiment, the invention is directed to a method for stabilizing a halogen-containing resin against elevated temperatures, UV light, oxidation, and high shear forces comprising adding to the halogen-containing resin a stabilizing amount of any of the above-described alkyltin sulfanyl ester thiols.

In another embodiment, the invention is directed to a process for the preparation of the above-described alkyltin sulfanyl ester thiols comprising the steps of reacting a mercaptocarboxylic acid and/or a mercaptoester with a mercaptoalcohol in the presence of a suitable catalyst to produce a dithiol ester; and reacting the dithiol ester with an alkyltin halide or alkyltin oxide at a S:Sn atom ratio greater than 2, greater than 4, or greater than 6, to form the alkyltin sulfanyl ester thiol. The dithiol ester preferably has the formula:

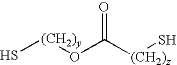

wherein y is 1, 2, 3, or 4; and z is 1, 2, 3, or 4. The alkyltin sulfanyl ester thiol preferably has the formula:

(R)ₓ—Sn—(R′)₄₋ₓ

wherein x is 1 or 2;

R is alkyl of from 1 to 12 carbon atoms; and

R′ is a moiety selected from the group consisting of:

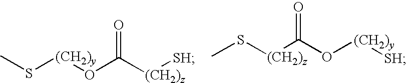

and mixtures thereof, wherein y is 1, 2, 3, or 4; and z is 1, 2, 3, or 4.

In another embodiment, the invention is directed to a mixture of compounds having the formula:

(R)ₓ—Sn—(R′)₄₋ₓ

wherein x is 1 for some compounds in the mixture, and x is 2 for other compounds in the mixture;

R is alkyl of from 1 to 12 carbon atoms; and

R′ is a moiety selected from the group consisting of:

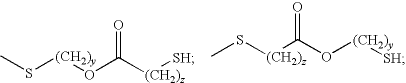

and mixtures thereof, wherein y is 1, 2, 3, or 4; and z is 1, 2, 3, or 4.

In another embodiment, the invention is directed to a compound of the formula:

(R)ₓ—Sn—(R′)₄₋ₓ

wherein x is 1 or 2;

R is alkyl of from 1 to 12 carbon atoms; and

R′ is a moiety selected from the group consisting of:

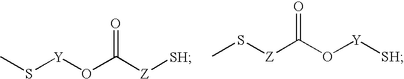

and mixtures thereof, wherein Y and Z are hydrocarbons, which may be linear, branched, saturated, unsaturated or cyclic. Y Preferably comprises from two to three carbon atoms and may be linear or branched. Z preferably comprises one to two carbon atoms.

In another embodiment, the invention is directed to a complex mixture comprising any of the above-described alkyltin sulfanyl ester thiols. The complex mixture optionally further comprises alkyltin compounds having a non-dithiol ester ligand, alkyltin compounds comprising a plurality of different dithiol ester ligands, and/or alkyltin compounds having a non-dithiol ester ligand.

### DESCRIPTION OF THE PREFERRED EMBODIMENTS

### Introduction

The invention relates to alkyltin thermal stabilizers for halogen-containing resin compositions and specifically to alkyltin sulfanyl ester thiols that have from one to three terminal thiol groups and are suitable for thermal stabilization of halogen-containing resins, e.g., PVC, compositions. The invention also relates to processes for forming such alkytin thermal stabilizers and to complex mixtures containing such stabilizers.

### Novel Alkyltin Thermal Stabilizers

The compounds of the present invention are of the formula:

(R)ₓ—Sn—(R′)₄₋ₓ

wherein x is 1, 2 or 3, preferably 1 or 2.

R is preferably alkyl of from 1 to 12 carbon atoms, e.g., methyl, ethyl, propyl, butyl, pentyl, hexyl, heptyl, octyl, nonyl, decyl, undecyl, dodecyl, isomers of the foregoing, e.g., ethylhexyl, t-butyl, and the like, and mixtures thereof. More preferably, R is alkyl of from one to eight carbon atoms; most preferably, methyl, butyl, or octyl.

R′ is a moiety selected from the group consisting of:

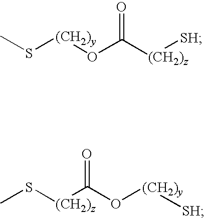

and mixtures thereof, wherein y is 1, 2, 3, or 4; and z is 1, 2, 3, or 4.

The dithiol esters employed are not limited to those that include straight hydrocarbon chains. Thus, in another embodiment, R′ is a moiety selected from the group consisting of:

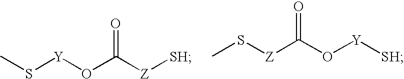

and mixtures thereof, wherein Y and Z are hydrocarbyl moities, which may be linear, branched, saturated, unsaturated or cyclic. In some preferred embodiments, Y comprises 1, 2, 3 or 4 carbon atoms. Z similarly preferably comprises 1, 2, 3 or 4 carbon atoms.

### Synthesis

The alkyltin sulfanyl ester thiol compounds of the present invention can be prepared via several synthetic routes. In a preferred embodiment, the alkyltin compounds of the invention are conveniently synthesized using a two-step reaction procedure that employs readily available reactants. First, a dithiol ester is prepared by esterification of a mercaptoalcohol with a mercaptocarboxylic acid, preferably in a molar ratio of from 0.8 to 1.1, e.g., from 1 to 1.05, and preferably about 1: 1, in the presence of a suitable catalyst. Thus, either reactant may be provided in excess relative to the other reactant. This reaction is shown below with reference to Reaction (IA).

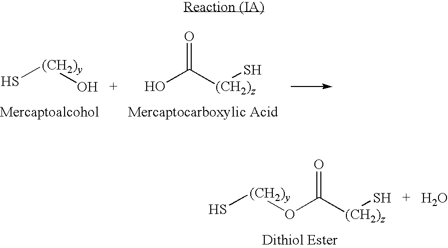

In the mercaptoalcohol, mercaptocarboxylic acid and the dithiol ester, above, y is 1, 2, 3, or 4; and z is 1, 2, 3, or 4.

Suitable mercaptoalcohols include, for example, 2-mercaptoethanol, 3-mercaptopropanol, 4-mercaptobutanol and 5-mercaptopentanol. Appropriate mercaptocarboxylic acids include, but are not limited to, thioglycolic (mercaptoacetic) acid, 2-mercaptopropanoic acid, 3-mercaptopropanoic acid, 4-mercaptobutanoic acid, and 5-mercaptopenanoic acid. Possible catalysts include, but are not limited to, p-toluene sulfonic acid, methane sulfonic acid, sulfuric acid, and titanium(IV) isopropoxide. The catalysts may, for example, be present in an amount ranging from 0.1 to 10 mol %, e.g., from 0.2 to 2 mol %, or from 0.3 to 1.2 mol %, based on the total molar amount of the limiting reactant employed and depending on the catalyst employed.

In another embodiment, illustrated below in Reaction (IB), the dithiol ester is prepared by transesterification of a mercaptoalcohol with a mercaptoester in the presence of a suitable catalyst. In this reaction, R₁ is an alkyl group, preferably a C₁ to C₁₀ alkyl group (e.g., a C₁ to C₁₀ alkyl group) such as methyl, ethyl, propyl, butyl, pentyl, phenyl, or substituted phenyl. Preferred mercaptoesters that may be employed in the transesterification reaction include: methyl thioglycolate, ethyl thioglycolate, or methyl-3-mercaptopropanoate. Preferred mercaptoalcohols include 2-mercaptoethanol and 3-mercaptopropanol.

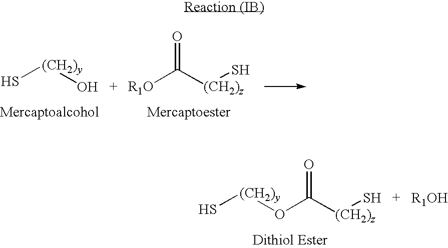

The esterification or transesterification reaction may be performed with or without a solvent at an appropriate temperature, for example, from 60 to 150° C., e.g., from 100 to 150° C. or from 130 to 150° C. If solvent is employed, the solvent may be selected, for example, from toluene, xylenes or cumene. Preferably, a slow flow of nitrogen gas is maintained over the mixture during the reaction. Possible catalysts include, but are not limited to, p-toluene sulfonic acid, methane sulfonic acid, sulfuric acid, and titanium(IV) isopropoxide. Water (or alcohol) formed during the reaction preferably is removed by conventional methods (e.g., distillation) that can be carried out under vacuum or at ambient pressure.

The resulting dithiol ester may be neutralized with an appropriate base such as sodium bicarbonate or potassium carbonate, purified by filtering salt residues out or by washing with water, and stripped, for example under 3 mm Hg vacuum, to remove organic solvents, if any, and moisture, preferably at an elevated temperature such as, for example, from 40 to 80° C., e.g., from 50 to 60° C., depending on the organic solvents employed in the reaction. Preferred dithiol esters that may be formed by the esterification or transesterification reactions, above, are listed below in Table 1.

TABLE 1
Preferred Dithiol Ester Compositions

| y | z | Name |
|---|---|---|
| 1 | 1 | mercaptomethyl thioglycolate |
| 1 | 2 | mercaptomethyl-3-mercaptopropanoate |
| 1 | 3 | mercaptomethyl-4-mercaptobutanoate |
| 1 | 4 | mercaptomethyl-5-mercaptopentanoate |
| 2 | 1 | 2-mercaptoethyl thioglycolate |
| 2 | 2 | 2-mercaptoethyl-3-mercaptopropanoate |
| 2 | 3 | 2-mercaptoethyl-4-mercaptobutanoate |
| 2 | 4 | 2-mercaptoethyl-5-mercaptopentanoate |
| 3 | 1 | 3-mercaptopropyl thioglycolate |
| 3 | 2 | 3-mercaptopropyl-3-mercaptopropanoate |
| 3 | 3 | 3-mercaptopropyl-4-mercaptobutanoate |
| 3 | 4 | 3-mercaptopropyl-5-mercaptopentanoate |
| 4 | 1 | 4-mercaptobutyl thioglycolate |
| 4 | 2 | 4-mercaptobutyl-3-mercaptopropanoate |
| 4 | 3 | 4-mercaptobutyl-4-mercaptobutanoate |
| 4 | 4 | 4-mercaptobutyl-5-mercaptopentanoate |
| 5 | 1 | 5-mercaptopentyl thioglycolate |
| 5 | 2 | 5-mercaptopentyl-3-mercaptopropanoate |
| 5 | 3 | 5-mercaptopentyl-4-mercaptobutanoate |
| 5 | 4 | 5-mercaptopentyl-5-mercaptopentanoate |

A non-limiting list of particularly preferred dithiol esters that may be used in the aforementioned condensation reaction to form the organotin compounds of the invention include: 2-mercaptoethyl thioglycolate, 2-mercaptoethyl-3-mercaptopropionate, and mixtures thereof.

In the second stage of the synthesis, the dithiol ester formed in the first stage is reacted with an appropriate reactant comprising tin, for example an alkyltin halide such as an alkyltin chloride or alkyltin oxide to form the desired alkyltin sulfanyl ester thiol. As each dithiol ester comprises two sulfur atoms, the S:Sn atom ratio for the reaction preferably is 6 or greater for the formation of a monoalkyltin sulfanyl thiols, 4 or greater for the formation of a dialkyltin sulfanyl thiols, and 2 or greater for the formation of a trialkyltin sulfanyl thiols. The resulting alkyltin sulfanyl ester thiol compounds thus contain both Sn—S bonds and free terminal thiol groups. A solvent for the alkytin chloride, such as water, may or may not be used. A base such as ammonia or ammonium hydroxide or sodium hydroxide may be used in order to react with the HCl formed and drive the reaction toward formation of the desired product.

Reaction (II), below, shows an exemplary second stage reaction between an organotin halide and a dithiol ester to form several alkyltin sulfanyl ester thiol compounds of the present invention. As discussed in greater detail below, due to the asymmetrical nature of dithiol esters, numerous constitutional isomers may be formed in Reaction (II) depending on the orientation of the dithiol ester relative to the alkyltin halide (or oxide) as shown by isomers 1-3. Isomers 1-3 are merely exemplary of a few possible reaction products, and it should be noted that additional products may be possible, including, for example, cyclic or oligomeric reaction products. In addition, without being bound by theory, it is believed that various reaction products may exchange between one another at room temperature.

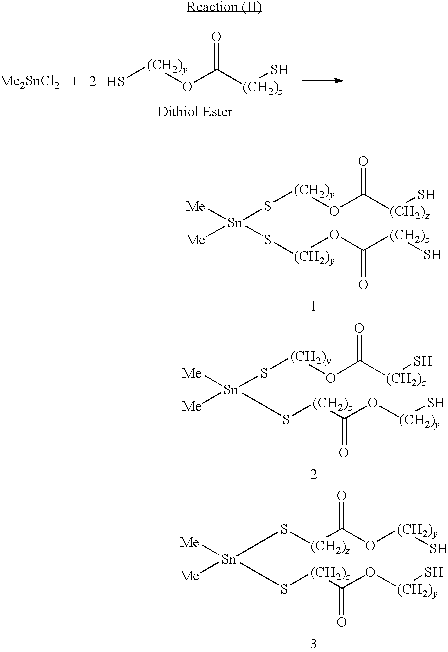

The organotin halide shown in Reaction (II) (dimethyltin dichloride) is merely exemplary and a wide variety of alkyltin halides and/or oxides may be employed in the reaction. A non-limiting list of suitable alkyltin halides and alkyltin oxides suitable for Reaction (II) to form alkyltin sulfanyl ester thiol compounds of the invention include, for example, monomethyltin trichloride, dimethyltin dichloride, dimethyltin oxide, monoethyltin trichloride, diethyltin dichloride, diethyltin oxide, dibutyltin oxide, monobutyltin trichloride, dibutyltin dichloride, monooctyltin trichloride and dioctyltin dichloride.

For nomenclature purposes, the alkyltin sulfanyl ester thiol compounds of the invention may be identified by the corresponding dithiol esters from which they may be (but are not necessarily) derived. For example, two equivalents of 2-mercaptoethyl thioglycolate may be reacted with dimethyltin dichloride to form a mixture comprising three alkyltin products, depending on the orientation of the dithiol esters relative to the dimethyltin dichloride compound, as shown in Reaction (III), below. As indicated above, additional products, e.g., oligomeric and/or cyclic products, may also be formed.

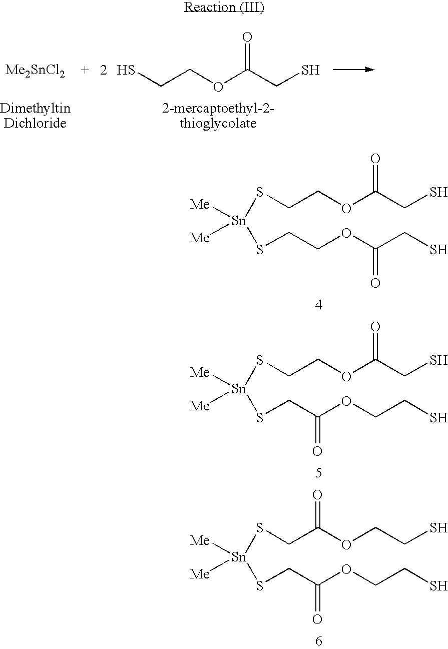

Since each of the reaction products 4-6 formed in Reaction (III) are formed from the reaction between dimethyltin dichloride and 2-mercaptoethyl thioglycolate, these reaction products may be referred to, separately or in combination, as dimethyltin bis(2-mercaptoethyl thioglycolate). Thus, as used herein, dimethyltin bis(2-mercaptoethyl thioglycolate) may be used to refer separately to product 4, product 5, or product 6, or to any combination thereof.

Employing this naming convention, a non-limiting list of exemplary alkyltin sulfanyl ester thiol compounds that may be formed according to various embodiments of the present invention include dimethyltin bis(2-mercaptoethyl thioglycolate), monomethyltin tris(2-mercaptoethyl thioglycolate), dimethyltin bis(2-mercaptoethyl-3-mercaptopropionate), monomethyltin tris(2-mercaptoethyl-3-mercaptopropionate), dibutyltin bis(2-mercaptoethyl thioglycolate), monobutyltin tris(2-mercaptoethyl thioglycolate), dibutyltin bis(2-mercaptoethyl-3-mercaptopropionate), monobutyltin tris(2-mercaptoethyl-3-mercaptopropionate), dioctyltin bis(2-mercaptoethyl thioglycolate), monooctyltin tris(2-mercaptoethyl thioglycolate), dioctyltin bis(2-mercaptoethyl-3-mercaptopropionate), monooctyltin tris(2-mercaptoethyl-3-mercaptopropionate), didodecyltin bis(2-mercaptoethyl thioglycolate), monododecyltin tris(2-mercaptoethyl thioglycolate), didodecyltin bis(2-mercaptoethyl-3-mercaptopropionate), monododecyltin tris(2-mercaptoethyl-3-mercaptopropionate), and mixtures thereof.

### Mixtures of Alkyltin Thermal Stabilizers

In another embodiment of the present invention, the alkyltin halide or alkyltin oxide is reacted in the second step with a plurality of different ligands (i.e., at least 2, at least 3, at least 4, at least 5 or more different ligands), at least one of the ligands comprising a dithiol ester, to form a complex mixture of reaction products, at least one of the ligands comprising a dithiol ester, such as those identified above. In various optional embodiments, the plurality of ligands may include one or more of the following in addition to the dithiol ester: sulfides, alkylmercaptides (such as, for example, those formed from lauryl mercaptan), ethylhexylthioglycolate, isooctylthioglycolate, ethylhexylmercaptopropanoate, 2-mercaptoethyl stearate, 2-mercaptoethyl oleate, 2-mercaptoethyl tallate, or 2-mercaptoethanol. Such complex mixtures are highly effective stabilizers for halogen-containing resin compositions such as PVC. As used herein, “complex mixture” refers to the products formed from the reaction between one or more alkyltin halides or alkyltin oxides with a plurality of ligands, at least one of the ligands comprising a dithiol ester. In this context, it should be understood that that various compounds may or may not be formed in a single reaction step to form the complex reaction product. Thus, the term complex reaction product also is meant to cover a mixture of alkyltin compounds having a plurality of different ligands, at least one of which comprises a dithiol ester, but which alkyltin compounds are formed separately and subsequently blended together. In one aspect of this embodiment, the complex reaction product comprises a plurality, i.e., two, three, four, or more, dithiol ester ligands and optionally one or more non-dithiol ester ligands. By a plurality of dithiol ester ligands it is meant a plurality of dithiol ester ligands derived from a plurality of different dithiol esters, not to be confused with the two respective ligands that may be formed from a single dithiol ester species due to the asymmetrical nature of the dithiol ester compound, as discussed above.

Thus, in some aspects, the alkyltin sulfanyl ester thiol compounds of the invention, e.g., as complex reaction products, include multiple ligands, where the ligands are chosen not only from the dithiol esters discussed above, but also from other ligands known in the art, particularly other ligands known in the art to have stabilizing properties, such as alkyl mercaptans, mercaptoalcohols, mercaptoacid esters, 2-mercaptoethyl esters, sulfides, phenols, and carboxylic acids. Examples of these ligands include, but are not limited to, butyl mercaptan, octyl mercaptan, decyl mercaptan, dodecyl mercaptan, 2-mercaptoethanol, 2-ethylhexylthioglycolate, 2-mercaptoethyl tallate, 2-mercaptoethyl oleate, 2-mercaptoethyl stearate, phenol, alkylphenols, maleic acid, lauric acid. Another example of the use of other ligands, is the use of sodium hydrogen sulfide, and of sodium sulfide, which introduces sulfur bridging between tin atoms.

In addition, the alkyltin species employed in the second step may comprise a monoalkyltin, a dialkyltin or both a monoalkyltin and a dialyltin. Trialkyltin compounds may also be employed, but are generally less favored due to increased toxicity. Table 2, below, lists various exemplary combinations of alkyltins and ligands that may be reacted to form alkyltin sulfanyl ester thiols according to various embodiments of the invention. Compounds listing more than one ligand are complex mixtures, as described above. Compounds naming monoalkytin and dialkyltin species are formed from both monoalkyltin and dialkyltin species.

TABLE 2
Exemplary Alkyltin sulfanyl Ester Thiols

| Alkyltin 1 | Alkyltin 2 | Ligand 1 | Ligand 2 | Ligand 3 |
|---|---|---|---|---|
| dimethyltin | monomethyltin | mercaptoethyl | — | — |
| | | thioglycolate | | |
| dimethyltin | — | mercaptoethyl | — | — |
| | | thioglycolate | | |
| dimethyltin | — | mercaptoethyl | — | — |
| | | mercaptopropanoate | | |
| dimethyltin | monomethyltin | mercaptoethyl | 2-mercaptoethyl | — |
| | | thioglycolate | tallate | |
| dimethyltin | — | mercaptoethyl | 2-mercaptoethyl | — |
| | | thioglycolate | tallate | |
| dimethyltin | monomethyltin | mercaptoethyl | 2-ethylhexyl | — |
| | | thioglycolate | thioglycolate | |
| dimethyltin | monomethyltin | mercaptoethyl | sulfide | — |
| | | thioglycolate | | |
| dimethyltin | monomethyltin | mercaptoethyl | sulfide | lauryl mercaptide |
| | | thioglycolate | | |
| dibutyltin | monobutyltin | mercaptoethyl | — | — |
| | | thioglycolate | | |
| dibutyltin | — | mercaptoethyl | — | — |
| | | thioglycolate | | |
| dibutyltin | monobutyltin | mercaptoethyl | 2-mercaptoethyl | — |
| | | thioglycolate | tallate | |
| dibutyltin | — | mercaptoethyl | 2-mercaptoethyl | — |
| | | thioglycolate | tallate | |
| dibutyltin | monobutyltin | mercaptoethyl | 2-ethylhexyl | — |
| | | thioglycolate | thioglycolate | |
| dibutyltin | monobutyltin | mercaptoethyl | sulfide | — |
| | | thioglycolate | | |
| dibutyltin | monobutyltin | mercaptoethyl | sulfide | lauryl mercaptide |
| | | thioglycolate | | |
| — | monooctyltin | mercaptoethyl | — | — |
| | | thioglycolate | | |
| — | monooctyltin | mercaptoethyl | 2-ethylhexyl | — |
| | | thioglycolate | thioglycolate | |
| — | monooctyltin | mercaptoethyl | sulfide | — |
| | | thioglycolate | | |
| dioctyltin | monooctyltin | mercaptoethyl | — | — |
| | | thioglycolate | | |
| dioctyltin | monooctyltin | mercaptoethyl | sulfide | — |
| | | thioglycolate | | |
| — | monooctyltin | mercaptoethyl | — | — |
| | | mercaptopropanoate | | |
| — | monooctyltin | mercaptoethyl | sulfide | — |
| | | mercaptopropanoate | | |
| dioctyltin | monooctyltin | mercaptoethyl | — | — |
| | | mercaptopropanoate | | |
| dioctyltin | monooctyltin | mercaptoethyl | sulfide | — |
| | | mercaptopropanoate | | |
| dimethyltin | monomethyltin | mercaptoethyl | 2-mercaptoethanol | sulfide |
| | | thioglycolate | | |
| dimethyltin | monomethyltin | mercaptoethyl | ethylene glycol | — |
| | | thioglycolate | dithioglycolate | |
| dibutyltin | monobutyltin | mercaptoethyl | 2-mercaptoethanol | lauryl mercaptide |
| | | mercaptopropanoate | | |

In another embodiment, the invention is directed to a mixture of compounds having the formula:

(R)ₓ—Sn—(R′)₄₋ₓ

wherein x is 1 for some compounds in the mixture, and x is 2 for other compounds in the mixture. R and R′ are as defined above. Preferably, the mixture includes more dialkyltin species than monoalkyltin species. In some exemplary embodiments, the mixture contains monoalkyltin species or moieties to dialkyltin species or moieties in a weight ratio of from 5:95 to 40:60, e.g., from 10:90 to 30:90, or about 20:80. Such mixtures may be formed, for example, by reacting a monoalkyltin halide or oxide and a dialkyltin halide or oxide, respectively, with one or more dithiol esters, preferably in single reaction vessel, at least one of the dithiol esters having the formula:

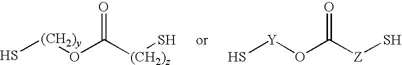

wherein y is 1, 2, 3, or 4; and z is 1, 2, 3, or 4, and wherein Y and Z are hydrocarbons, which may be linear, branched, saturated, unsaturated or cyclic. In some preferred embodiments, Y comprises two or three carbon atoms, e.g., straight-chain ethylene or straight or branched chain propylene. Z preferably comprises one or two carbon atoms.

In this embodiment, as with those discussed above, the mono- and di-alkyltin halides or alkyltin oxides may be reacted with a plurality of different ligands (i.e., at least 2, at least 3, at least 4, at least 5 or more different ligands), at least one of the ligands comprising a dithiol ester, to form a complex mixture of reaction products, at least one of the ligands comprising a dithiol ester, such as any of those identified above. Thus, the mono- and di-alkyltin halides or oxides may be reacted with one or more non-dithiol esters in addition to the one or more dithiol esters in the manner described above. For example, the mono- and di-alkyltin halide or oxide compounds may be reacted with one or more of the following non-dithiol esters in addition to the one or more dithiol ester: alkyl mercaptans, mercaptoalcohols, mercaptoacid esters, 2-mercaptoethyl esters, sulfides, phenols, and carboxylic acids. Examples of these compounds include, but are not limited to, butyl mercaptan, octyl mercaptan, decyl mercaptan, dodecyl mercaptan, 2-mercaptoethanol, 2-ethylhexylthioglycolate, 2-mercaptoethyl tallate, 2-mercaptoethyl oleate, phenol, alkylphenols, maleic acid, and lauric acid. In one embodiment, the non-dithiol ester is selected from sodium hydrogen sulfide, and sodium sulfide, which introduce sulfur bridging between tin atoms. The resulting blends may provide the desired balance of early color hold and long term heat stability.

Although it is preferred to react the alkyltin species (whether monoalkyl, dialkyl or both) with one or more ligands in a single reaction vessel, in another embodiment a plurality of reaction vessels or steps may be employed in which one or more ligands are reacted with the alkyltin species in a first reaction vessel or step and one or more different ligands are reacted with the alkyltin species in one or more subsequent reaction vessel(s) or step(s).

In another embodiment, the alkyltin sulfanyl ester thiols of the invention may be used as a stabilizer in combination with one or more sulfur-containing compounds that do not contain tin, also referred to herein as free ligands. The free ligands may be blended with the alkyltin sulfanyl ester thiol products of the invention after synthesis of the alkyltin sufanyl ester thiol, or may be left over from an excess of sulfur containing compounds provided to the above-described second stage reaction. Thus, in one embodiment, an excess of one or more of the mercaptocarboxylic acids and/or mercaptoesters may be used in the second stage reaction, resulting in a lower overall tin content. A non-limiting list of free ligands, one or more of which may be employed in combination with the alkyltin sulfanyl ester thiols of the invention, includes: mercaptocarboxylic acids, mercaptoesters, alkyl mercaptans, mercaptoalcohols, mercaptoacid esters, 2-mercaptoethyl esters and sulfides. Examples of these ligands include, but are not limited to any of those listed in Table 1, above, butyl mercaptan, octyl mercaptan, decyl mercaptan, dodecyl mercaptan, 2-mercaptoethanol, 2-ethylhexylthioglycolate, 2-mercaptoethyl tallate, 2-mercaptoethyl oleate, and 2-mercaptoethyl stearate.

In another embodiment, the alkyltin sulfanyl ester thiols of the invention may be used as a stabilizer in combination with one or more alkyl tin halides or alkyl tin oxides, which may be the same or different alkyl tin halide or oxide used to form the alkyltin sulfanyl ester thiol. The alkyl tin halide or oxide may be blended with the alkyltin sulfanyl ester thiol products of the invention after synthesis of the alkyltin sufanyl ester thiol, or may be left over from an excess of alkyl tin halide or oxide provided to the above-described second stage reaction. Thus, in one embodiment, an excess of one or more alkyl tin halides and/or oxides may be used in the second stage reaction. Exemplary alkyltin halides and oxides are provided above.

### Applications and Thermal Stabilization

The alkyltin compounds of the present invention preferably impart superior thermal stability to halogen-containing resins. The halogens of such resins can be fluorine, chlorine, bromine, iodine, or mixtures thereof. The polymer that is stabilized by the compounds of the present invention is preferably PVC, more preferably chlorinated PVC (CPVC).

The PVC used can be obtained via polymerization in bulk or in suspension, or in emulsion, or in micro suspension, or in suspended emulsion.

As employed herein, the terms “poly(vinyl chloride)” and “PVC” are intended to include both homopolymers and copolymers of vinyl chloride, i.e., vinyl resins containing vinyl chloride units in their structure, e.g., copolymers of vinyl chloride and vinyl esters of aliphatic acids, in particular vinyl acetate; copolymers of vinyl chloride with esters of acrylic and methacrylic acid and with acrylonitrile; copolymers of vinyl chloride with diene compounds and unsaturated dicarboxylic acids or anhydrides thereof, such as copolymers of vinyl chloride with diethyl maleate, diethyl fumarate or maleic anhydride; post-chlorinated polymers and copolymers of vinyl chloride; copolymers of vinyl chloride and vinylidene chloride with unsaturated aldehydes, ketones and others, such as acrolein, crotonaldehyde, vinyl methyl ketone, vinyl methyl ether, vinyl isobutyl ether, and the like.

The terms “poly(vinyl chloride)” and “PVC” as employed herein are also intended to include graft polymers of PVC with EVA, ABS, and MBS. Preferred substrates are also mixtures of the above-mentioned homopolymers and copolymers, in particular vinyl chloride homopolymers, with other thermoplastic and/or elastomeric polymers, in particular blends with ABS, MBS, NBR, SAN, EVA, CPE, MBAS, PMA, PMMA, EPDM, and polylactones.

Vinyl acetate, vinylidene dichloride, acrylonitrile, chlorofluoroethylene and/or the esters of acrylic, fumaric, maleic and/or itaconic acids are preferred examples of monomers that are copolymerizable with vinyl chloride. In addition, polyvinyl chloride can be chlorinated having a chlorine content of up to 70% by weight. This invention applies particularly to the vinyl chloride homopolymers.

Within the scope of this invention, PVC will also be understood to include recyclates of halogen-containing polymers that have suffered damage by processing, use or storage.

An effective amount of the alkyltin compound of the present invention is an amount that makes the halogen-containing resin more resistant to discoloration than the resin per se. Generally, an effective amount will range from about 0.2 to about 1.50 parts of the stabilizer per hundred parts resin, e.g., from 0.5 to 1.5 parts or from 0.5 to 1.2 parts of the stabilizer per hundred parts resin, and will depend on the specific resin and alkyltin compound, as well as the degree of thermal stabilization desired.

The alkyltin compound may be added to the halogen-containing resin using techniques and apparatus well known to those of ordinary skill in this art. Generally, the resin may be mixed with the stabilizer in a high-speed mixer for 30 to 90 seconds to thoroughly disperse the alkyltin compound throughout the resin.

The halogen-containing resin may also contain known additives, as long as their presence does not materially degrade the thermal stability imparted by the alkyltin compounds of the present invention. Such additives may include, without limitation, lubricants, fillers, pigments, flame retardants, UV absorbers, impact modifiers, and processing aids. These additives may be added to the resin using techniques and apparatus well known to those of ordinary skill in this art.

Suitable lubricants include calcium stearate, montan wax, fatty acid esters, polyethylene waxes, chlorinated hydrocarbons, glycerol esters, and combinations thereof. Suitable fillers include titanium oxide, calcium carbonate, kaolin, glass beads, glass fibers, talc, wood flour, and mixtures thereof.

Suitable pigments include azo pigments, phthalocyanine pigments, quinacridone pigments, perylene pigments, diketopyrrolopyrrole pigments and anthraquinone pigments. Suitable flame retardants include antimony oxide, molybdates, borates, and hydroxystannates.

Various features and aspects of the present invention are illustrated further in the examples that follow. While these examples are presented to show one skilled in the art how to operate within the scope of the invention, they are not intended in any way to serve as a limitation upon the scope of the invention.

### EXAMPLES

### Example 1

### Synthesis of 2-Mercaptoethyl thioglycolate

Mercaptoethanol (78.12 g), thioglycolic acid (96.73 g), methanesulfonic acid (0.7 g), and toluene (150 mL) were combined in a 500 mL round bottom flask equipped with a stirrer, a reflux condenser, and a cooled Dean-Stark trap. The flask was heated with an electric mantle, and a slow current of nitrogen was kept flowing over the reaction mixture. The temperature of the mixture increased from 96° C. to 126° C. since the first drop of water was collected in the trap until no more water could be collected. The process took 70 minutes, and 24 g of water were collected in the trap (theoretical 18 g).

After cooling down the mixture to room temperature, it was washed with 7% NaHCO₃ and then with water. The aqueous washes were washed with toluene and all the toluene fractions were combined. The toluene was stripped under vacuum until it could not be detected by GC in the final product. 139 g of 2-mercaptoethyl thioglycolate was obtained, which was a single peak by GC analysis. This represents 91.3% of the theoretical yield.

### Example 2

### Synthesis of Dimethyltin bis(2-Mercaptoethyl thioglycolate)

2-Mercaptoethyl thioglycolate (84.1 grams, 37.5% mercaptan value by iodine titration) was reacted with 50.3 grams of dimethyltin dichloride dissolved in 50 ml of water. The reaction mixture was neutralized, while stirring, with 28% ammonium hydroxide solution. During neutralization, the temperature was allowed to rise up to 64° C.; the final pH was 6.5 - 7. The crude liquid product was separated from the aqueous phase and stripped under 3 mm Hg at 60° C. for three hours and at 80° C. for 30 minutes, using a Büchi Rotavapor R-1 14 evaporator. The product was filtered to remove traces of residual salts to yield 109 grams of the clear liquid product.

### Example 3

### Evaluation of Color Stability

Rigid PVC formulations were prepared using the stabilizer of Example 1 and commercially available methyltin stabilizer Mark 1900, a blend of monomethyltin-tris(2-ethylhexylthioglycolate) with dimethyltin-bis(2-ethyl hexylthioglycolate). The stabilizers were applied at the same weight in the formulations. Each PVC compound test sample was placed into a Brabender mixer operated at 190° C. and 65 RPM. Sample chips were taken every three minutes. Fusion time was about the same for all samples.

Color stability was determined from sample chips using a Hunter Lab calorimeter measuring Yellowness Index (YI). The lower the YI, the less the amount of discoloration as a result of thermal decomposition, signifying superior thermal stabilization.

TABLE 3
Effect of Heat Stabilizers on Yellowness Index of PVC

| Time (minutes) | Mark 1900 | Dimethyltin mercaptoethyl thioglycolate |
|---|---|---|
| 3 | 5.33 | 3.42 |
| 6 | 6.96 | 5.58 |
| 9 | 10.62 | 13.68 |
| 12 | 15.27 | — |
| Stabilizer | 1.2 | 1.2 |
| added, phr | | |

“Initial color hold” refers to yellowing resistance during the first 3 to 9 minutes of the Brabender color stability test. Monoalkyltin stabilizers are known to provide an excellent initial color-hold, generally better than that provided by dialkyltin stabilizers.

Blends of the monoalkyltin and dialkyltin moieties provide the most efficient balance of both initial color-hold and long-term heat stability. One such blend is a mixture of monomethyltin tris-(2-ethylhexylthioglycolate) and dimethyltin bis-(2-ethylhexylthioglycolate), which is commercially available from Chemtura Corporation under the trade designation Mark 1900.

Added at the same weight, the dimethyltin mercaptoethyl thioglycolate stabilizer of the present invention achieved an initial color stability superior to that of the Mark 1900 blend, as measured by yellowness index, especially at 3 and 6 minutes (see Table 3). In other words, the dimethyltin mercaptoethyl thioglycolate stabilizer was unexpectedly effective in initial color stabilization despite the absence of a monoalkyltin moiety in its composition.

In view of the many changes and modifications that can be made without departing from principles underlying the invention, reference should be made to the appended claims for an understanding of the scope of the protection to be afforded the invention.

What is claimed is:

1. A compound of the formula:
(R)ₓ—Sn—(R′)₄₋ₓ
wherein x is 1 or 2;
R is alkyl of from 1 to 12 carbon atoms; and
R′ is a moiety selected from the group consisting of: 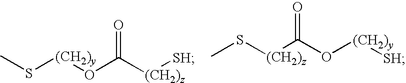
and mixtures thereof, wherein y is 1, 2, 3, or 4; and z is 1, 2, 3, or 4.

2. The compound of claim 1, wherein R is selected from the group consisting of methyl, butyl, t-butyl, ethylhexyl, and octyl.

3. The compound of claim 1, wherein R is alkyl of from one to eight carbon atoms.

4. The compound of claim 1, wherein R is methyl, butyl, or octyl.

5. The compound of claim 1, wherein the compound is selected from the group consisting of dimethyltin bis(2-mercaptoethyl thioglycolate), monomethyltin tris(2-mercaptoethyl thioglycolate), dimethyltin bis(2-mercaptoethyl 3-mercaptopropionate), monomethyltin tris(2-mercaptoethyl 3-mercaptopropionate), dibutyltin bis(2-mercaptoethyl thioglycolate), monobutyltin tris(2-mercaptoethyl thioglycolate), dibutyltin bis(2-mercaptoethyl 3-mercaptopropionate), monobutyltin tris(2-mercaptoethyl 3-mercaptopropionate), dioctyltin bis(2-mercaptoethyl thioglycolate), monooctyltin tris(2-mercaptoethyl thioglycolate), dioctyltin bis(2-mercaptoethyl 3-mercaptopropionate), monooctyltin tris(2-mercaptoethyl 3-mercaptopropionate), didodecyltin bis(2-mercaptoethyl thioglycolate), monododecyltin tris(2-mercaptoethyl thioglycolate), didodecyltin bis(2-mercaptoethyl 3-mercaptopropionate), monododecyltin tris(2-mercaptoethyl 3-mercaptopropionate), and mixtures thereof.

6. A composition comprising:
(A) a halogen-containing resin; and
(B) an effective amount of the compound of claim 1 to stabilize the halogen-containing resin against elevated temperatures, UV light, oxidation, and high shear forces.

7. The composition of claim 6, wherein R is methyl, butyl, or octyl.

8. The composition of claim 6, wherein the compound is selected from the group consisting of dimethyltin bis(2-mercaptoethyl thioglycolate), monomethyltin tris(2-mercaptoethyl thioglycolate), dimethyltin bis(2-mercaptoethyl 3-mercaptopropionate), monomethyltin tris(2-mercaptoethyl 3-mercaptopropionate), dibutyltin bis(2-mercaptoethyl thioglycolate), monobutyltin tris(2-mercaptoethyl thioglycolate), dibutyltin bis(2-mercaptoethyl 3-mercaptopropionate), monobutyltin tris(2-mercaptoethyl 3-mercaptopropionate), dioctyltin bis(2-mercaptoethyl thioglycolate), monooctyltin tris(2-mercaptoethyl thioglycolate), dioctyltin bis(2-mercaptoethyl 3-mercaptopropionate), monooctyltin tris(2-mercaptoethyl 3-mercaptopropionate), didodecyltin bis(2-mercaptoethyl thioglycolate), monododecyltin tris(2-mercaptoethyl thioglycolate), didodecyltin bis(2-mercaptoethyl 3-mercaptopropionate), monododecyltin tris(2-mercaptoethyl 3-mercaptopropionate), and mixtures thereof.

9. The composition of claim 6, wherein the halogen-containing resin is selected from the group consisting of PVC and polyvinyl bromide.

10. The composition of claim 6, wherein the effective amount is within a range of from about 0.5 to about 1.50 parts of the compound per hundred parts the resin.

11. A method for stabilizing a halogen-containing resin against elevated temperatures, UV light, oxidation, and high shear forces comprising adding to the halogen-containing resin a stabilizing amount of the compound of claim 1.

12. The method of claim 11, wherein R is methyl, butyl, or octyl.

13. The method of claim 11, wherein the compound is selected from the group consisting of dimethyltin bis(2-mercaptoethyl thioglycolate), monomethyltin tris(2-mercaptoethyl thioglycolate), dimethyltin bis(2-mercaptoethyl 3-mercaptopropionate), monomethyltin tris(2-mercaptoethyl 3-mercaptopropionate), dibutyltin bis(2-mercaptoethyl thioglycolate), monobutyltin tris(2-mercaptoethyl thioglycolate), dibutyltin bis(2-mercaptoethyl 3-mercaptopropionate), monobutyltin tris(2-mercaptoethyl 3-mercaptopropionate), dioctyltin bis (2-mercaptoethyl thioglycolate), monooctyltin tris(2-mercaptoethyl thioglycolate), dioctyltin bis (2-mercaptoethyl 3-mercaptopropionate), monooctyltin tris(2-mercaptoethyl 3-mercaptopropionate), didodecyltin bis(2-mercaptoethyl thioglycolate), monododecyltin tris(2-mercaptoethyl thioglycolate), didodecyltin bis(2-mercaptoethyl 3-mercaptopropionate), monododecyltin tris(2-mercaptoethyl 3-mercaptopropionate), and mixtures thereof.

14. A method for the preparation of an alkyltin sulfanyl ester thiol, comprising:
(a) reacting a mercaptocarboxylic acid with a mercaptoalcohol in the presence of a suitable catalyst to produce a dithiol ester; and
(b) reacting the dithiol ester with an alkyltin halide or alkyltin oxide at a S:Sn atom ratio greater than 2 to form the alkyltin sulfanyl ester thiol.

15. The method of claim 14, wherein the S:Sn atom ratio is greater than 4.

16. The method of claim 14, wherein the dithiol ester has the formula: 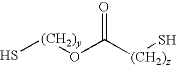
wherein y is 1, 2, 3, or 4; and z is 1, 2, 3, or 4.

17. The method of claim 14, wherein the alkyltin sulfanyl ester thiol has the formula:
(R)ₓ—Sn—(R′)₄₋ₓ
wherein x is 1 or 2;
R is alkyl of from 1 to 12 carbon atoms; and
R′ is a moiety selected from the group consisting of: 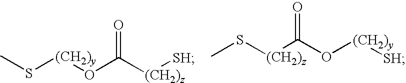
and mixtures thereof, wherein y is 1, 2, 3, or 4; and z is 1, 2, 3, or 4.

18. The method of claim 14, wherein the alkyltin sulfanyl ester thiol is selected from the group consisting of dimethyltin bis(2-mercaptoethyl thioglycolate), monomethyltin tris(2-mercaptoethyl thioglycolate), dimethyltin bis(2-mercaptoethyl 3-mercaptopropionate), monomethyltin tris(2-mercaptoethyl 3-mercaptopropionate), dibutyltin bis(2-mercaptoethyl thioglycolate), monobutyltin tris(2-mercaptoethyl thioglycolate), dibutyltin bis(2-mercaptoethyl 3-mercaptopropionate), monobutyltin tris(2-mercaptoethyl 3-mercaptopropionate), dioctyltin bis(2-mercaptoethyl thioglycolate), monooctyltin tris(2-mercaptoethyl thioglycolate), dioctyltin bis(2-mercaptoethyl 3-mercaptopropionate), monooctyltin tris(2-mercaptoethyl 3-mercaptopropionate), didodecyltin bis(2-mercaptoethyl thioglycolate), monododecyltin tris(2-mercaptoethyl thioglycolate), didodecyltin bis(2-mercaptoethyl 3-mercaptopropionate), monododecyltin tris(2-mercaptoethyl 3-mercaptopropionate), and mixtures thereof.

19. A mixture of compounds having the formula:
(R)ₓ—Sn—(R′)₄₋ₓ
wherein x is 1 for some compounds in the mixture, and x is 2 for other compounds in the mixture;
R is alkyl of from 1 to 12 carbon atoms; and
R′ is a moiety selected from the group consisting of: 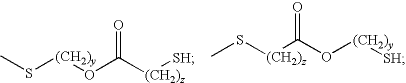
and mixtures thereof, wherein y is 1, 2, 3, or 4; and z is 1, 2, 3, or 4.

20. A compound of the formula:
(R)ₓ—Sn—(R′)₄₋ₓ
wherein x is 1 or 2;
R is alkyl of from 1 to 12 carbon atoms; and
R′ is a moiety selected from the group consisting of: 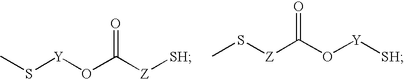
and mixtures thereof, wherein Y and Z are hydrocarbons, which may be linear, branched, saturated, unsaturated or cyclic.

21. The compound of claim 20, wherein Y comprises from two to three carbon atoms and linear or branched.

22. The compound of claim 21, wherein Z comprises one to two carbon atoms.

23. A complex mixture comprising the compound of any one of claims 1 or 20.

24. The complex mixture of claim 23, further comprising alkyltin compounds having a non-dithiol ester ligand.

25. The complex mixture of claim 23, further comprising alkyltin compounds comprising a plurality of different dithiol ester ligands.

26. The complex mixture of claim 25, further comprising alkyltin compound having a non-dithiol ester ligand.
